(19) United States
(12) Patent Application Publication
(10) Pub. No.: US 2006/0286018 A1
(43) Pub. Date: Dec. 21, 2006

(54) Method and reactor arrangement of reducing the emission of nitrogen oxides

(76) Inventor: Rudolf Jenny, Bern (CH)

Correspondence Address: OSTROLENK FABER GERB & SOFFEN, 1180 AVENUE OF THE AMERICAS, NEW YORK, NY, 100368403, US

(21) Appl. No.: 10/556,735

(22) PCT Filed: May 14, 2003
(86) PCT No.: PCT/CH03/00310

§ 371 Date: Nov. 14, 2005

(51) Int. Cl. B01D 53/86

(52) U.S. Cl. 423/235

(57) ABSTRACT

Nitric acid is widely used for oxidizing purposes, e.g. for dissolving (precious) metals and for oxidation reactions of organic compounds. It is proposed to suppress the generation and emission of nitrogen oxides, the products of the reduction of nitric acid, by introducing ozone charged gas into the reaction medium. A suitable reactor arrangement (1) comprises an ozone containing gas supply unit (5) connected by a conduit (33) to a reactor (3). Preferably, the conduit (33) ends below the surface (15) of the reaction medium (17).

The present invention relates to a method for reducing the emission of gaseous nitrogen oxides according to the preamble of claim 1. Furthermore, it relates to a reactor arrangement for executing the method.

Nitrogen oxides are generated e.g. by oxidation reactions with nitric acid (HNO₃) as one reactant. The acid may be used in a pure state, i.e. as an aqueous solution of appropriate concentration, or mixed with other components. One of the most prominent partners is hydrochloric acid yielding aqua regia for solving precious metals like gold. However, also oxidation reactions of organic substances are performed in applying nitric acid as the oxidizing agent.

By the oxidation reaction, the nitric acid is reduced, whereby nitrogen oxides are generated which leave the reaction medium as gases. However, due to health and environment protection provisions, these gases shall not be emitted into the air.

Hence, the waste gases from such reactors are cleaned by gas washers, where the nitrogen oxides are absorbed and bound. The active component of the gas washers has a certain life time and/or has to be exchanged regularly.

Another possibility of avoiding the emission of nitrogen oxides is the oxidation in situ by adding hydrogen peroxide (H₂O_{2aq}) to the reaction medium. However, thereby, water is added to the reaction medium which negatively influences the reaction conditions and has to be removed eventually. Furthermore, if no stabilizers are present in the hydrogen peroxide solution, it is difficult to handle and can not be preserved. The stabilizers, on the other hand, may disturb the chemical reaction and have to be removed later on.

Accordingly, it is one object of the present invention to propose a method for suppressing the generation of nitrogen oxide generation in situ and to less disturb the oxidation reaction.

Such a method is defined in claim 1. The further claims present preferred embodiments and reactor arrangements for executing the method.

Generally, the invention is based on the suprising discovery that ozone may be used to reoxidize the reaction products of the reduction of nitric acid (HNO₃) in situ. Particularly, it has been found that supplying e.g. oxygen with an effective content of ozone may be supplied to a reaction solution for oxidatively solving metals without disturbing the oxidation reaction of nitric acid.

Furthermore, ozone containing gas may also be supplied to reaction mixtures for oxidizing organic substances. In these applications, however, depending on the reaction and the reaction partners, the ozone may interfere with the desired oxidation process, so the use of ozone at all or the composition of the ozone charged gas has to be tested more carefully as in the inorganic applications.

A preferred manner of supplying the ozone containing gas is a conduit or tube extending into the reaction medium. The ozone containing gas emanates from the end of the conduit and bubbles through the reaction medium, thereby reoxidizing the nitrogen oxides.

Advantageously, the end of the conduit is provided with means like a frit for creating many small bubbles in order to increase the exchange rate of ozone between the bubbles and the solution.

The invention will be explained by means of execution examples. The only

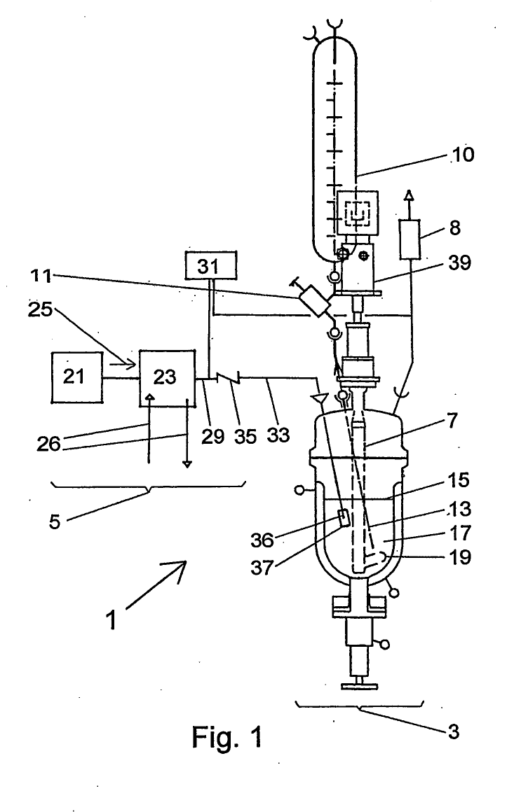

FIG. 1 shows a schematical representation of a reactor arrangement

The reactor arrangement 1 consists of the reactor 3, which is provided with a supply unit 5 for the ozone containing gas. Otherwise, the reactor may be of conventional structure. Here, it is provided with a stirrer 7, driven by a motor 8, and a drop funnel 10 with valve 11, which allows the adjustable addition of e.g. HNO₃ or aqua regia (nitrohydrochloric acid). In this example, a tube 13 guides the agent well below the surface 15 of the reaction solution 17 near the blade 19 of the stirrer 7 for immediate and effective mixing.

The ozone supply unit 5 comprises a gas supply 21 providing air, oxygen or a mixture thereof. The gas passes the ozone generator 23 according to arrow 25. Inter alia, the ozone generator is provided with a tubing 26 for a cooling liquid.

At the exit 29 of the ozone generator 23, an ozone measuring instrument 31 is connected as well as the conduit 33 to the reactor 3. For security reasons, a nonreturn valve 35 is integrated in the conduit 33. The gas conduit 33 extends into the interior of the reactor with its end 36 below the surface 15 of the reaction solution 17. The end 36 is provided with a frit body 37 for subdividing the exiting gas into small bubbles.

The reactor 3 is further provided with a venting tube 39, which is provided with an ozon destroyer unit 40 for removing residual ozone from the exiting gas. Ahead of the destroyer unit 40, the ozone measuring instrument 31 is connected with the venting tube 39. By measuring the difference of ozone contents before and after the reactor, the reoxidation reaction and indirectly the main reaction can be observed.

Obviously, due to the instability of ozone and its decay into oxygene, the destroying of residual ozone is possible without effort. The elements of the ozone supply unit 5 and the residual ozone destroyer unit 40 are known per se and, therefore, do not need to be described in detail. The destruction of the ozone may be done thermically and without use of any chemical agents.

One application example for oxidation by nitric acid is the production of nitrate salts of metals and of chlor compounds (complexes) of precious metals. Some exemplary reactions will be given.

Ex. 1: Copper

Oxidation

Cu+4HNO₃=Cu(NO₃)₂+2NO₂+2H₂O

Ozonisation (Reoxidation NO₂)

2NO₂+O₃=N₂O₅+O₂

Reaction with water

N₂O₅+H₂O=2HNO₃

Total reaction (non-reduced)

Cu+4HNO₃+O₃=Cu(NO₃)₂+2HNO₃+O₂+H₂O

As a result, half of the nitric acid is recycled and no nitrogen oxide is produced.

Ex. 2: Gold/Aqua Regia

Oxidation

Au+HNO₃+4HCl=H[AuCl₄]+NO+2H₂O

Ozonisation (Reoxidation of NO₂)

a) 2NO+2O₃=2NO₂+2O₂

b) 2NO₂+O₃=N₂O₅+O₂

Reaction with Water

N₂O₅+H₂O=2 HNO₃

Total Reaction (Non-Reduced)

2Au+2HNO₃+8HCl+3O₃+H₂O=2 H[AuCl]+HNO₃+4H₂O+3 O₂

The nitric acid is recycled in its entirety and no nitrogen oxide gas is produced.

Regarding the overall reaction, oxygen appears as the reduction product of ozone. In contrast, if the same reactions are performed using H₂O₂, water results, hence the reaction solution is diluted and for obtaining the products, the addtionally created water has to be removed by vaporization, requiring considerable energy.

For best results, the addition rate of ozone is stoichiometric with regard to the addition of the other agents, e.g. the addition of nitric acid resp. aqua regia. Of course, alternatively, the metal may be added continuously to the acid, e.g. as metal flakes.

For this purpose, a photometer (not shown) may be used that is sensitive to the colour of nitrogen dioxide (NO₂). The photometer examines the exhaust gas of the reactor. If it detects NO₂, it creates an appropriate signal which is used to increase the rate of ozone addition. The rate of addition of ozone may be adjusted by regulating the total-flux of ozone containing gas, and/or by changing the ozone content.

A preferred range of ozone content is 2 to 15% by weight of ozone in the gas.

On the basis of the examples given above, the one skilled in the art may conceive numerous variants and applications of the invention without leaving the scope of protection which is defined by the claims.

For instance, as mentioned in the beginning, the method may also be used for oxidation processes of organic components. The necessary preliminary experiments for determining the correct process conditions, as ozone may react undesirably with one of the other agents, particularly an organic reactance, are a routine measure.

Another aspect consists in that the reaction rate of ozone with any nitrogen oxide NOₓ is of first order. Hence, by varying the concentration of the nitric acid concentration and/or the ozone concentration, the selectivity of the reaction of ozone with either NO, or other components of the reaction mixture may be adjusted for best results and yield.

It is still conceivable that the carrier gas for the ozone has another composition: E.g. it may contain inert gases like argon.

1. Method for reducing the emission of gaseous nitrogen oxides in an oxidation process in condensed phase with nitric acid (HNO₃) present in an effective amount to act as an oxidizing agent, wherein a gas stream is introduced into the condensed phase, wherein the gas stream contains an effective content of ozone in order to prevent generation of nitrogen oxide gas.

2. Method according to claim 1, wherein the condensed phase is a liquid phase, preferably with water as the main liquid constituent, and more preferably the only liquid constituent.

3. Method according to claim 1, wherein the oxidation process comprises the oxidation of a metal by direct or indirect reaction with nitric acid, whereby the nitric acid is reduced.

4. Method according to claim 3, wherein the metal is more precious than hydrogen in an aqueous medium, more preferable the metal is one of copper and precious metals like gold.

5. Method according to claim 1, wherein the oxidation reaction comprises the oxidation of an organic component directly or indirectly by nitric acid, the component being, though, substantially inert with respect to ozone.

6. Method according to claim 1, wherein the gas stream is air, oxygen or a mixture thereof, containing additionally ozone.

7. Method according to claim 1, wherein the gas stream contains 2-15% by weight of ozone.

8. Method according to claim 1, wherein the rate of ozone introduction into the reaction medium is chosen sufficiently high that no nitrogen oxides emanate from the reaction medium, preferably no nitrogen dioxide.

9. Method according to claim 1, wherein the gas stream containing ozone is introduced into the reaction medium so that the gas passes through the medium in bubbles.

10. Reactor arrangement for performing the method according to claim 1, comprising an ozone supply unit and a conduit connecting the ozone supply unit with the reactor.

11. Reactor arrangement according to claim 10, wherein one end of the conduit is provided with a frit for generating small bubbles of gas.

12. Reactor arrangement according to claim 10, wherein the rate of ozone introduction is adjustable by an ozone rate adjustment device, the device being able to control at least one of gas flux and ozone generation rate.

13. Reactor arrangement according to claim 10, wherein a photometric device is provided which is sensitive to gaseous nitrogen dioxide, the photometric device being arranged to detect an appearance of nitrogen dioxide in the reactor and being operatively connected to the ozone rate adjustment device so that the ozone rate is adjustable in an automatic manner to a value where the generation of nitrogen dioxide is essentially, preferably totally, suppressed.
